(19) United States
(12) Patent Application Publication
(10) Pub. No.: US 2025/0341303 A1
(43) Pub. Date: Nov. 6, 2025

(54) LED LIGHT TUBE MULTI-LAYER STRUCTURE

(71) Applicant: KOCAM INTERNATIONAL CO., LTD., New Taipei (TW)

(72) Inventor: TSAN-JUNG CHEN, New Taipei (TW)

(21) Appl. No.: 19/192,172

(22) Filed: Apr. 28, 2025

(30) Foreign Application Priority Data
May 3, 2024 (TW) 113204478

(51) Int. Cl. F21V 25/12; F21V 3/06; F21V 15/015; F21V 19/00; F21V 31/00; F21Y 115/10

(52) U.S. Cl. CPC F21V 25/12; F21V 3/0625; F21V 15/015; F21V 19/005; F21V 31/005; F21Y 2115/10

(57) ABSTRACT

The invention provides an LED light tube multi-layer structure comprising: a flexible cover body, an opening is formed on a top of the flexible cover body and an accommodating space is formed inside, and an inner cover surface is formed on an inner side and a flexible flame-retardant layer is disposed on the inner cover surface; a plurality of fixing members, the fixing members are connected to the flexible cover body to form the opening on the top of the flexible cover body and the accommodating space inside the flexible cover body and are connected to the flexible flame-retardant layer; and at least one LED module, the LED module is assembled with the flexible cover body, and at least one light-emitting member is disposed on one side of the LED module, thereby, the flexible cover body can be directly connected and fixed by the fixing members.

### BACKGROUND OF THE INVENTION

### Field of Invention

The invention relates to an LED light tube, more particularly to an LED light tube multi-layer structure capable of saving assembly and manufacturing costs and providing waterproof and flame-retardant effects.

### Related Art

With the development of LED (Light Emitting Diode) lighting technology, LED is increasingly used in people's daily life. With the application of linear light sources, low-power lamps have gradually evolved into high-power LED light tubes. For LED light sources, the increase in luminous power also increases the demand for temperature control and heat dissipation. Therefore, in order to extend the service life of LED light tubes and achieve good lighting effects, LED modules need to be used in conjunction with heat sinks. The high heat generated by LED is guided to the environment outside the lamp by the heat dissipation module. The conventional assembly between the LED light tube and the heat sink is achieved by snap fitting, so the manufacturing costs of the LED light tube are high. After the assembly, the LED light tube cannot achieve an efficacy of fire source protection, and the LED light tube and the heat sink cannot achieve an efficacy of waterproofing, so a waterproof structure and a fire source protection structure need to be provided to perform waterproofing and fire source protection, which will increase the assembly costs and manufacturing costs of the LED light tube.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively solve the above-mentioned problems, a main object of the invention is to provide an LED light tube multi-layer structure capable of saving assembly and manufacturing costs and providing waterproof and flame-retardant effects.

Another object of the invention is to provide an LED light tube multi-layer structure capable of increasing a light diffusion effect.

In order to achieve the above-mentioned objects, the invention provides an LED light tube multi-layer structure comprising: a flexible cover body, an opening is formed on a top of the flexible cover body and an accommodating space is formed inside, and an inner cover surface is formed on an inner side of the flexible cover body and a flexible flame-retardant layer is disposed on the inner cover surface of the flexible cover body; a plurality of fixing members, the fixing members are connected to the flexible cover body to form the opening on the top of the flexible cover body and the accommodating space inside the flexible cover body; and at least one LED module, the LED module is assembled with the flexible cover body, and at least one light-emitting member is disposed on one side of the LED module.

According to one embodiment of the LED light tube multi-layer structure of the invention, wherein the flexible cover body is further provided with a diffusion layer, and the diffusion layer is disposed between the flexible flame-retardant layer and the inner cover surface.

According to one embodiment of the LED light tube multi-layer structure of the invention, wherein the top of the flexible cover body is formed with a first top and a second top, and the fixing member is connected to the first top and the second top to form the opening on the top of the flexible cover body and the accommodating space inside.

According to one embodiment of the LED light tube multi-layer structure of the invention, wherein the flexible cover body is formed by rolling up a light-transmitting soft substrate to form the opening and the accommodating space.

According to one embodiment of the LED light tube multi-layer structure of the invention, wherein the flexible flame-retardant layer is formed by rolling up a light-transmitting soft substrate and is attached to the inner cover surface.

According to one embodiment of the LED light tube multi-layer structure of the invention, wherein the LED module is disposed on a lower side of the fixing member, and the LED module is combined with the fixing member by a module adhesive layer and is assembled with the flexible cover body through the fixing member.

According to one embodiment of the LED light tube multi-layer structure of the invention, wherein the LED module is disposed on an upper side of the fixing member and is assembled with the flexible cover body through the fixing member, and the light-emitting member disposed on one side of the LED module is correspondingly disposed between the fixing members.

According to one embodiment of the LED light tube multi-layer structure of the invention, further comprising a waterproof cover body, the waterproof cover body being combined with the flexible cover body by a cover body adhesive layer and covering the LED module and the fixing member.

According to one embodiment of the LED light tube multi-layer structure of the invention, wherein the flexible cover body has a first end formed at one end and a second end formed at another end, and a coating layer is respectively provided on the first end and the second end, and the coating layer closes the accommodating space.

According to one embodiment of the LED light tube multi-layer structure of the invention, wherein at least one control circuit is disposed in the accommodating space, and the control circuit is electrically connected to the LED module.

According to an embodiment of the LED light tube multi-layer structure of the invention, wherein the LED module is attached to two sides of an interior of the flexible cover body.

According to one embodiment of the LED light tube multi-layer structure of the invention, wherein a material of the flexible cover body is polyethylene terephthalate (PET).

According to one embodiment of the LED light tube multi-layer structure of the invention, wherein a material of the flexible flame-retardant layer is polycarbonate (PC).

### BRIEF DESCRIPTION OF THE DRAWINGS

FIG. 1 is a plan view of an LED light tube multi-layer structure of the invention.

FIG. 2 is a perspective view of the LED light tube multi-layer structure of the invention.

FIG. 3 is a schematic diagram of implementation of the LED light tube multi-layer structure with a waterproof cover body of the invention.

FIG. 4 is a schematic diagram of implementation of the LED light tube multi-layer structure with a coating layer of the invention.

FIG. 5 is another plan view of the LED light tube multi-layer structure of the invention.

FIG. 6 is another perspective view of the LED light tube multi-layer structure of the invention.

FIG. 7 is another schematic diagram of implementation of the LED light tube multi-layer structure with the waterproof cover body of the invention.

FIG. 8 is a first schematic diagram of implementation of disposition of an LED module of the LED light tube multi-layer structure of the invention.

FIG. 9 is a second schematic diagram of implementation of disposition of the LED module of the LED light tube multi-layer structure of the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to an LED light tube multi-layer structure of the invention, various applicable examples are exemplified and explained in detail with reference to the accompanying drawings; however, the invention is of course not limited to the enumerated embodiments, drawings, or detailed descriptions.

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numbers.

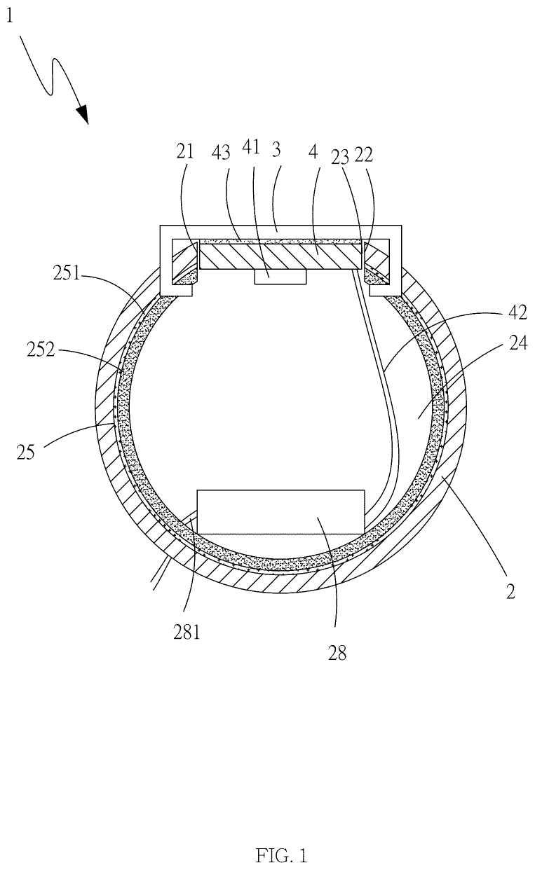

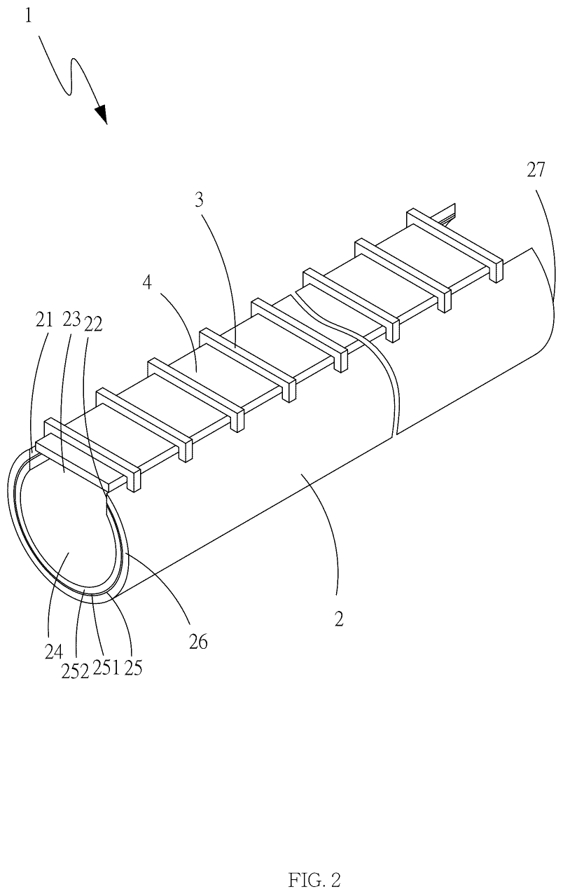

Please refer to FIG. 1 and FIG. 2 respectively for a plan view and a perspective view of an LED light tube multi-layer structure of the invention, wherein an LED light tube multi-layer structure 1 comprises a flexible cover body 2, a plurality of fixing members 3 and at least one LED module 4.

Wherein the flexible cover body 2 is a light-transmitting soft substrate, and the flexible cover body 2 can be formed of a crack-resistant material such as polyethylene terephthalate (PET), but is not limited thereto. The flexible cover body 2 is formed by rolling up the light-transmitting soft material, the flexible cover body 2 is formed with a first top 21 and a second top 22 at a top, an opening 23 is formed between the first top 21 and the second top 22 at the top of the flexible cover body 2, and an accommodating space 24 communicated to the opening 23 is formed inside the flexible cover body 2. An inner cover surface 25 is formed on an inner side of the flexible cover body, and a diffusion layer 251 and a flexible flame-retardant layer 252 are provided on the inner cover surface 25, wherein the diffusion layer 251 coats the inner cover surface 25, the flexible flame-retardant layer 252 is formed by rolling up a light-transmitting soft substrate, and the flexible flame-retardant layer 252 can be formed by a material with flame-retardant properties such as polycarbonate (PC), but is not limited thereto, and the flexible flame-retardant layer 252 is coated on the diffusion layer 251. An area coated by the diffusion layer 251 is equivalent to an area of the inner cover surface 25, the flexible flame-retardant layer 252 is completely coated on the inner cover surface 25. The flexible cover body 2 is formed with a first end 26 penetrating into the accommodating space 24 at one end, and a second end 27 penetrating into the accommodating space 24 at another end, and the flexible cover body 2 is provided with at least one control circuit 28 in the accommodating space 24.

Wherein the fixing member 3 is connected to the first top 21 and the second top 22. In this embodiment, the fixing member 3 is a staple and passes through the first top 21 and the second top 22 respectively, so that the flexible cover body 2 can be rolled up, and the flexible cover body 2 is positioned by the fixing member 3 at the first top 21 and the second top 22 to form the opening 23 and the accommodating space 24. The fixing member 3 passes through the diffusion layer 251 and the flexible flame-retardant layer 252 at the same time, so that the flexible flame-retardant layer 252 and the flexible cover body 2 are rolled up with each other and disposed inside and outside, the fixing member 3 is disposed correspondingly at the opening 23, and the fixing member 3 can be a staple or a metal wire or a metal plate or a plastic wire or a plastic plate.

Wherein the LED module 4 is assembled with the flexible cover body 2, at least one light-emitting element 41 is formed on one side of the LED module 4. The LED module 4 is electrically connected to the control circuit 28 by a conductive line 42, and the control circuit 28 is disposed at the first end 26 or the second end 27 and provides power for the LED module 4. The control circuit 28 is electrically connected externally by an electric wire 281 by passing through the flexible cover body 2 or passing through the diffusion layer 251, the flexible flame-retardant layer 252 and the flexible cover body 2. In this embodiment, the LED module 4 is disposed on a lower side of the fixing member 3, and the LED module 4 is combined with the fixing member 3 by a module adhesive layer 43 and is assembled with the flexible cover body 2 through the fixing member 3.

In addition, wherein an inner side or an outer side of the light-transmitting soft substrate can be coated or covered with the diffusion layer 251. In this embodiment, the diffusion layer 251 is coated on an inner side of the light-transmitting soft substrate, and then the flexible flame-retardant layer 252 is disposed on the diffusion layer 251, and then rolled up to form the flexible cover body 2, i.e., the flexible flame-retardant layer 252, so that the diffusion layer 251 and the flexible flame-retardant layer 252 are disposed on an inner side of the flexible cover body 2, and the flexible flame-retardant layer 252 and the flexible cover body 2 are rolled up with each other and disposed inside and outside. When the light-emitting element 41 generates a light source, the diffusion layer 251 can be utilized to achieve an efficacy of light diffusion. In contrast, a conventional light tube is integrally formed into a U-shaped body, when an inner side or an outer side of the U-shaped body is covered or coated with a diffusion material, it is easy to cause the diffusion material to be incapable of being completely covered or to be unevenly coated due to an angle of rolling up. Comparatively, the LED light tube multi-layer structure 1 is formed by laying a light-transmitting soft substrate flat to coat or cover the diffusion layer, and then rolling up into the flexible cover body 2, so that the flexible cover body 2 is capable of achieving an efficacy of increasing a light diffusion effect.

In this way, in addition to the flexible cover body 2 being formed by rolling up a light-transmitting soft substrate to reduce material costs and achieve a waterproof effect, the flexible cover body 2 can be directly fixed by the fixing member 3, capable of saving manufacturing costs in setting up additional snap-fitting structures in the prior art, thereby achieving an efficacy of saving manufacturing costs. The flexible cover body 2 is provided with the flexible flame-retardant layer 252 on an inner side, if electronic components inside the flexible cover body 2 cause a fire source, the flexible flame-retardant layer 252 is capable of exerting a flame-retardant effect and producing a protective efficacy inside the flexible cover body 2.

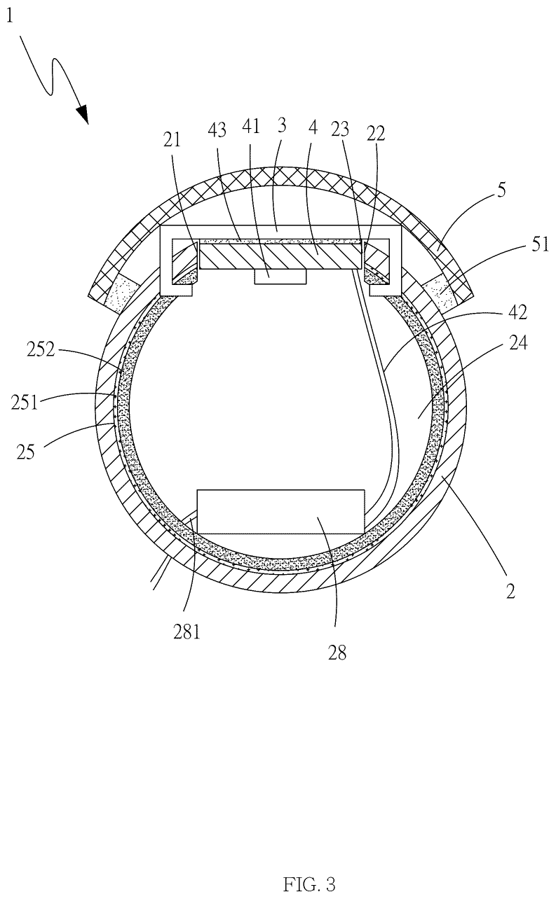

Please refer to the above-mentioned figures, and FIG. 3 for a schematic diagram of implementation of the LED light tube multi-layer structure with a waterproof cover body of the invention. In this embodiment, components of the LED light tube multi-layer structure 1 and corresponding relationships between the components are the same as those of the above-mentioned embodiments of the LED light tube multi-layer structure 1, so they are not repeated herein. However, the LED light tube multi-layer structure 1 of this embodiment further comprises a waterproof cover body 5, the waterproof cover body 5 is combined with the flexible cover body 2 by a cover body adhesive layer 51 and covers the LED module 4 and the fixing member 3, thereby the waterproof cover body 5 closes a top of the flexible cover body 2 and a top side of the accommodating space 24. In addition to the flexible cover body 2 capable of reducing material costs by rolling up a light-transmitting soft substrate, the flexible cover body 2 and the waterproof cover body 5 can be directly adhered and fixed by the cover body adhesive layer 51 to close the accommodating space 24, further capable of saving manufacturing costs and assembly costs in setting up additional snap-fitting structures and waterproof structures in the prior art, thereby achieving efficacies of saving assembly and manufacturing costs and providing a waterproof effect at the same time.

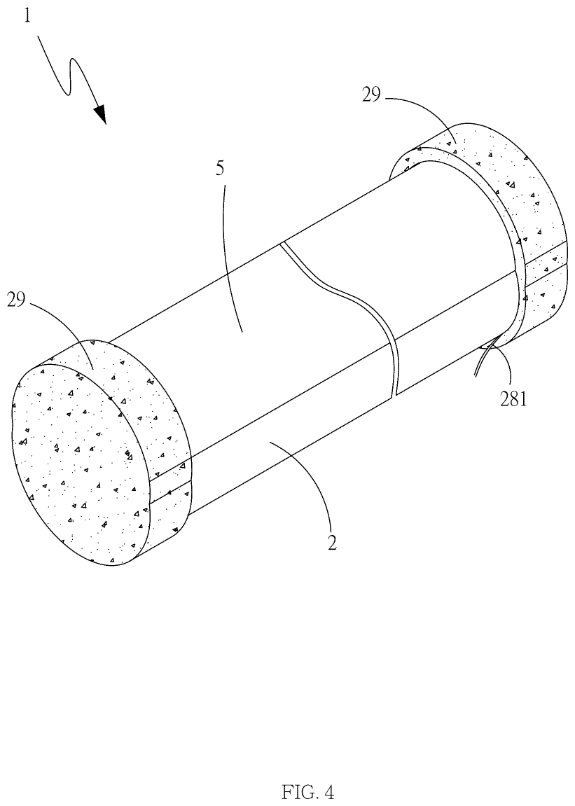

Please refer to the above-mentioned figures, and FIG. 4 for a schematic diagram of implementation of the LED light tube multi-layer structure with a coating layer of the invention. In this embodiment, components of the LED light tube multi-layer structure 1 and corresponding relationships between the components are the same as those of the above-mentioned embodiments of the LED light tube multi-layer structure 1, so they are not repeated herein. However, in the LED light tube multi-layer structure 1 of this embodiment, wherein a coating layer 29 is provided on the first end 26 and the second end 27 respectively, and the coating layer 29 completely covers the first end 26 and the second end 27, thereby closing the two ends of the flexible cover body 2 and two sides of the accommodating space 24. In addition, a top of the flexible cover body 2 and a top side of the accommodating space 24 are sealed by the waterproof cover body 5 and the cover body adhesive layer 51 completely. In this way, in addition to the flexible cover body 2 capable of reducing material costs by rolling up a light-transmitting soft substrate, the flexible cover body 2 and the waterproof cover body 5 can be directly adhered and fixed by the cover body adhesive layer 51 to close the accommodating space 24, and the accommodating space 24 is sealed by the coating layer 29, further capable of saving manufacturing costs and assembly costs in setting up additional snap-fitting structures and waterproof structures in the prior art, thereby achieving efficacies of saving assembly and manufacturing costs and providing a waterproof effect at the same time.

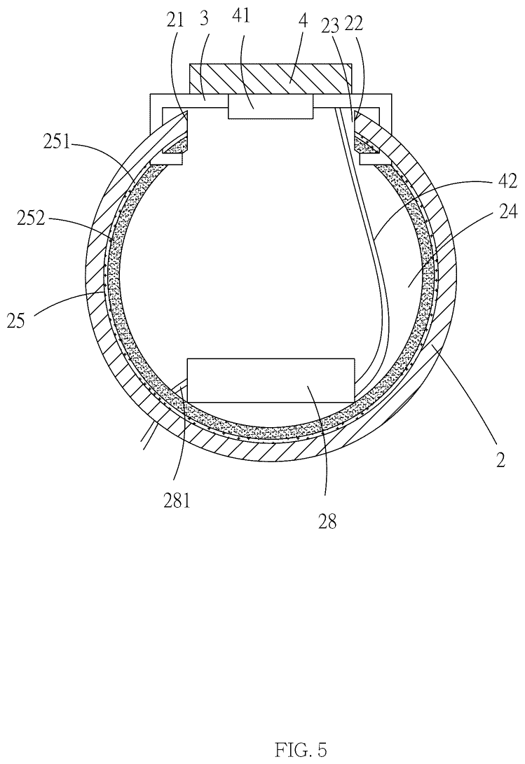

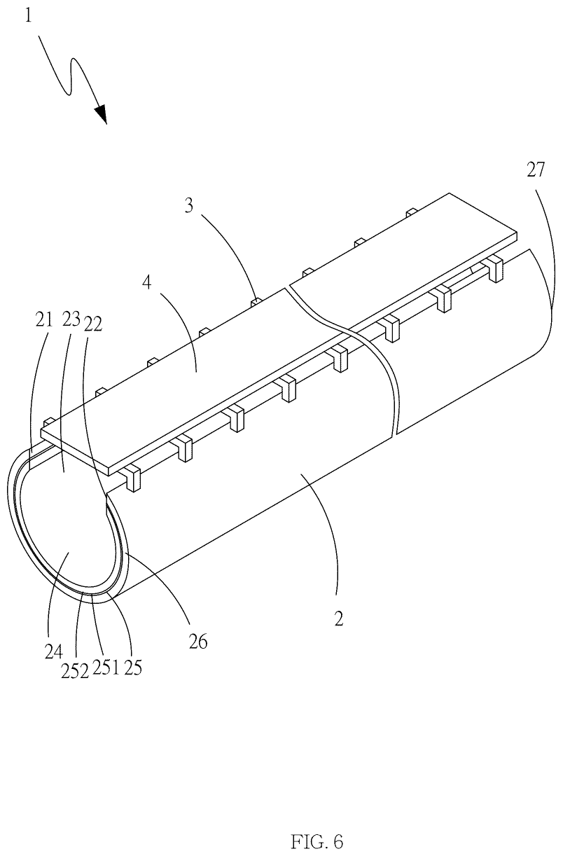

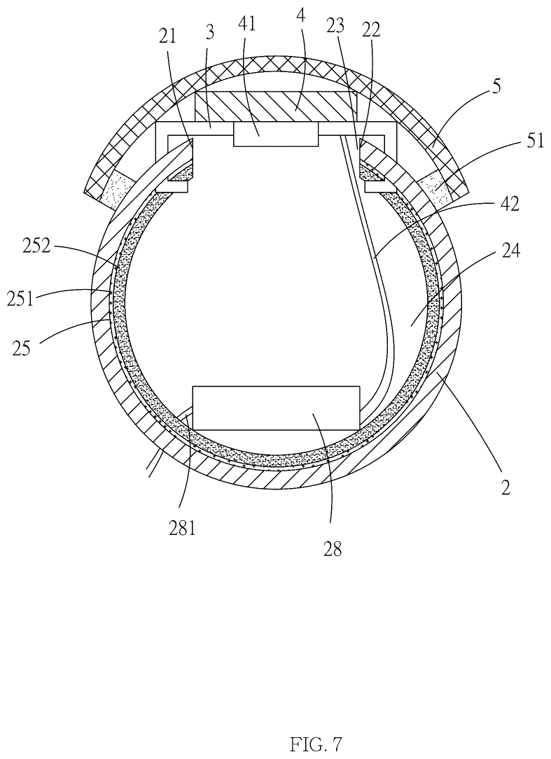

Please refer to the aforementioned figures, and FIGS. 5 to 7 respectively for another plan view and another perspective view of the LED light tube multi-layer structure of the invention, as well as another schematic diagram of implementation of the LED light tube multi-layer structure with the waterproof cover body of the invention. In this embodiment, components of the LED light tube multi-layer structure 1 and corresponding relationships between the components are the same as those of the above-mentioned embodiments of the LED light tube multi-layer structure 1, so they are not repeated herein. However, in the LED light tube multi-layer structure 1 of this embodiment, wherein the LED module 4 is disposed on an upper side of the fixing member 3, the LED module 4 is assembled with the flexible cover body 2 and the flexible flame-retardant layer 252 by the fixing member 3, and the light-emitting member 41 disposed on one side of the LED module 4 is correspondingly disposed between the fixing members 3. Therefore, in addition to the flexible cover body 2 capable of reducing material costs by rolling up a light-transmitting soft substrate, the flexible cover body 2 can be directly fixed by the fixing member 3, further capable of saving manufacturing costs in setting up additional snap-fitting structures in the prior art, thereby achieving an efficacy of saving manufacturing costs.

Further, wherein the waterproof cover body 5 is combined with the flexible cover body 2 by the cover body adhesive layer 51 and covers the LED module 4 and the fixing member 3, thereby a top of the flexible cover body 2 and a top side of the accommodating space 24 are closed by the waterproof cover body 5. In this way, in addition to the flexible cover body 2 capable of reducing material costs by rolling up a light-transmitting soft substrate, the flexible cover body 2 and the waterproof cover body 5 can be directly adhered and fixed by the cover body adhesive layer 51 to close the accommodating space 24, further capable of saving manufacturing costs and assembly costs in setting up additional snap-fitting structures and waterproof structures in the prior art, thereby achieving efficacies of saving assembly and manufacturing costs and providing a waterproof effect at the same time.

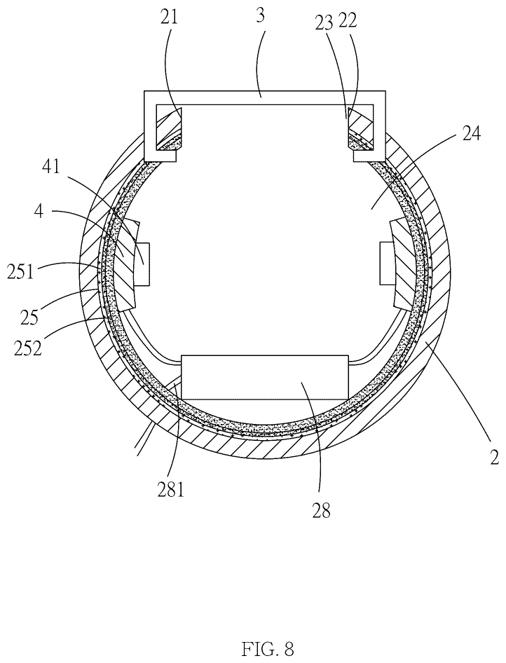

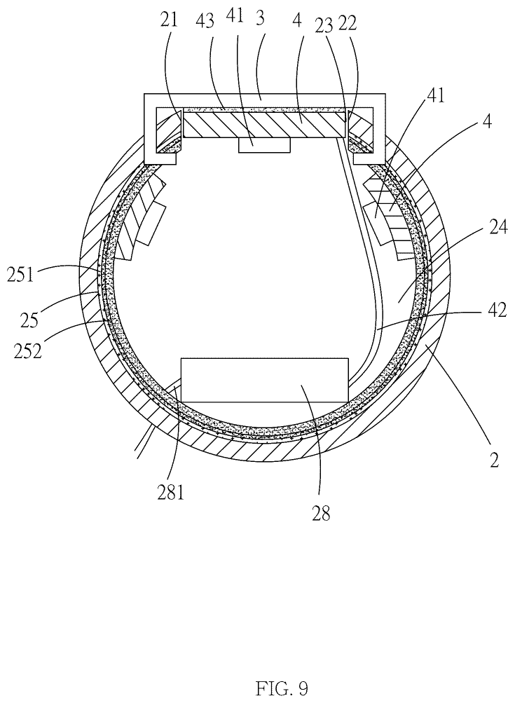

Please refer to the aforementioned figures, and FIGS. 8 and 9 respectively for first and second schematic diagrams of implementation of disposition of the LED module of the LED light tube multi-layer structure of the invention. In this embodiment, wherein the LED modules 4 are respectively attached to two sides of a horizontal line inside the flexible cover body 2; or, the three LED modules 4 are disposed, one of the LED modules 4 is assembled with the fixing member 3 at a top, the LED modules 4 on two sides are respectively attached to two sides inside the flexible cover body 2, and light emitting angles of the LED modules 4 on two sides form an included angle with a horizontal line, and light emitting angles of the LED modules 4 on two sides and the LED module 4 on a top also form an included angle.

The invention has been described in detail above, but the above description merely illustrates the preferred embodiments of the invention, and should not be used to limit a scope implemented by the invention, that is, all equivalent changes and modifications made according to the applied scope of the invention should still fall within the scope covered by the appended claims of the invention.

What is claimed is:

1. An LED light tube multi-layer structure comprising:
a flexible cover body, an opening being formed on a top of the flexible cover body and an accommodating space being formed inside, and an inner cover surface being formed on an inner side of the flexible cover body and a flexible flame-retardant layer being disposed on the inner cover surface of the flexible cover body;
a plurality of fixing members, the fixing members being connected to the flexible cover body to form the opening on the top of the flexible cover body and the accommodating space inside the flexible cover body; and
at least one LED module, the LED module being assembled with the flexible cover body, and at least one light-emitting member being disposed on one side of the LED module.

2. The LED light tube multi-layer structure as claimed in claim 1, wherein the flexible cover body is further provided with a diffusion layer, and the diffusion layer is disposed between the flexible flame-retardant layer and the inner cover surface.

3. The LED light tube multi-layer structure as claimed in claim 1, wherein the top of the flexible cover body is formed with a first top and a second top, and the fixing member is connected to the first top and the second top to form the opening on the top of the flexible cover body and the accommodating space inside.

4. The LED light tube multi-layer structure as claimed in claim 1, wherein the flexible cover body is formed by rolling up a light-transmitting soft substrate to form the opening and the accommodating space.

5. The LED light tube multi-layer structure as claimed in claim 1, wherein the flexible flame-retardant layer is formed by rolling up a light-transmitting soft substrate and is attached to the inner cover surface.

6. The LED light tube multi-layer structure as claimed in claim 1, wherein the LED module is disposed on a lower side of the fixing member, and the LED module is combined with the fixing member by a module adhesive layer and is assembled with the flexible cover body through the fixing member.

7. The LED light tube multi-layer structure as claimed in claim 1, wherein the LED module is disposed on an upper side of the fixing member and is assembled with the flexible cover body through the fixing member, and the light-emitting member disposed on one side of the LED module is correspondingly disposed between the fixing members.

8. The LED light tube multi-layer structure as claimed in claim 1, further comprising a waterproof cover body, the waterproof cover body being combined with the flexible cover body by a cover body adhesive layer and covering the LED module and the fixing member.

9. The LED light tube multi-layer structure as claimed in claim 1, wherein the flexible cover body has a first end formed at one end and a second end formed at another end, and a coating layer is respectively provided on the first end and the second end, and the coating layer closes the accommodating space.

10. The LED light tube multi-layer structure as claimed in claim 1, wherein at least one control circuit is disposed in the accommodating space, and the control circuit is electrically connected to the LED module.

11. The LED light tube multi-layer structure as claimed in claim 1, wherein the LED module is attached to two sides of an interior of the flexible cover body.

12. The LED light tube multi-layer structure as claimed in claim 4, wherein a material of the flexible cover body is polyethylene terephthalate (PET).

13. The LED light tube multi-layer structure as claimed in claim 5, wherein a material of the flexible flame-retardant layer is polycarbonate (PC).
